(19) United States
(12) Patent Application Publication
(10) Pub. No.: US 2025/0328108 A1
(43) Pub. Date: Oct. 23, 2025

(54) WRISTWATCH

(71) Applicant: SBANG S.r.I, Torino (IT)

(72) Inventor: Andrea MURER, Torino (TO) (IT)

(73) Assignee: SBANG S.r.I, Torino (IT)

(21) Appl. No.: 18/870,050

(22) PCT Filed: May 26, 2023
(86) PCT No.: PCT/IB2023/055398

§ 371 Date: Nov. 27, 2024

(30) Foreign Application Priority Data
May 27, 2022 (IT) 102022000011282

(51) Int. Cl. G04B 19/28; G04B 19/18

(52) U.S. Cl. CPC G04B 19/283; G04B 19/18

(57) ABSTRACT

A wristwatch whereby at least one rotational assembly, arranged between bezels and one of either a containing member or another of the bezels, and the rotational assembly being provided with at least one rotating body in contact with at least one of the bezels due to the rotation of at least one of the same, thereby promoting the rotation thereof and reducing the friction thereof with the other of the bezels and/or the containing member.

### TECHNICAL FIELD

The present invention relates to a wristwatch.

### BACKGROUND ART

A wide variety of wristwatches of the analog type are particularly known to employ a hand mechanism to indicate the time on a reference scale given on a special dial.

The watch mechanism and dial are protected within the so-called watch case.

The time is then read through a special opening cut into the case and closed by a clear glass.

In addition, bezels have been known to be mounted on the watch case with other reference scales on the surface which can be used in conjunction with the hands to indicate other time data.

The bezels, in fact, can rotate around the dial to allow the angular position of the corresponding reference scale to be adjusted, e.g., to indicate the time zone of other countries or to time the elapsed time as of a given instant.

In this, this type of watches provide the user with additional functions beyond that of indicating the current time.

However, these types of watches do have some drawbacks.

In particular, the rotation of the bezels generates friction with the other bezels and/or with the watch case and makes adjusting the angular position of the bezel complicated and awkward.

In addition, the presence of one or more bezels greatly complicates the assembly and disassembly operations of the watch, thus increasing its maintenance, repair and similar costs.

### DESCRIPTION OF THE INVENTION

The main aim of the present invention is to devise a wristwatch which allows easy, fast and particularly smooth rotation of the watch bezels compared to the watches of known type.

An additional object of the present invention is to devise a wristwatch which allows for simplified watch assembly and disassembly operations compared to the watches of known type.

Another object of the present invention is to devise a wristwatch which allows the aforementioned drawbacks of the prior art to be overcome within the framework of a simple, rational solution that is easy and effective to use as well as inexpensive.

The aforementioned objects are achieved by this wristwatch having the characteristics of claim 1.

### BRIEF DESCRIPTION OF THE DRAWINGS

Other characteristics and advantages of the present invention will become more apparent from the description of a preferred, but not exclusive, embodiment of a wristwatch, illustrated by way of an indicative, yet non-limiting example, in the attached tables of drawings in which:

FIG. 1 is an axonometric view of the wristwatch according to the invention;

FIG. 2 is an exploded view of the wristwatch according to the invention;

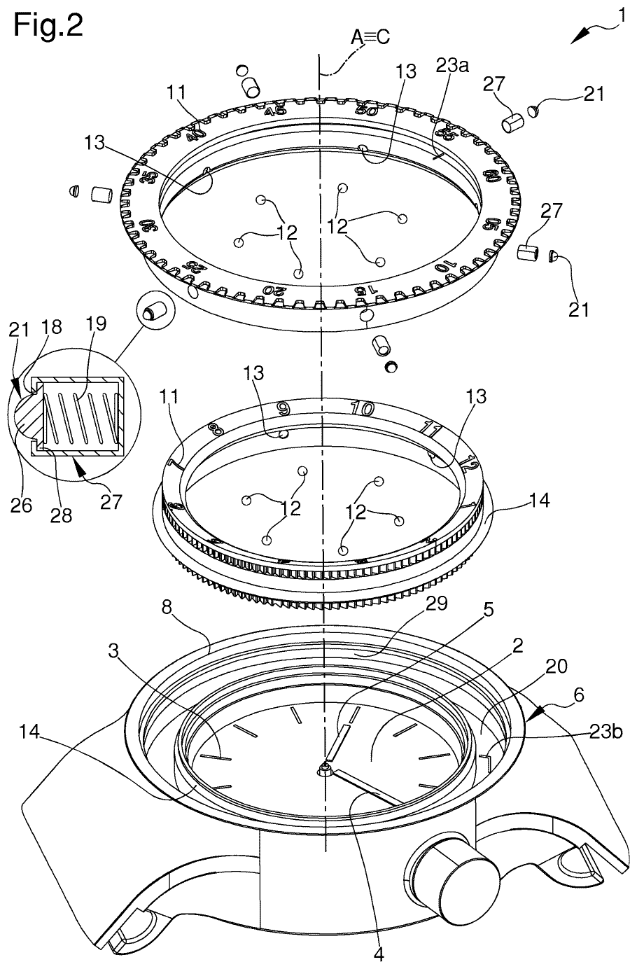

FIG. 3 is a sectional view of one embodiment of the wristwatch according to the invention;

FIG. 4 is a sectional view of another embodiment of the wristwatch according to the invention.

### EMBODIMENTS OF THE INVENTION

With particular reference to these figures, reference numeral 1 globally denotes a wristwatch.

The wristwatch 1 comprises:
at least one dial 2 provided with a reference scale 3;
at least one hand mechanism 4, 5 provided with at least one minute hand 4 and at least one hour hand 5 for reading the time on the reference scale 3;
at least one containing member 6, defining at least one housing 7 of the mechanism 4, 5 and of the dial 2 and defining at least one upper opening 8 through which the dial 2 and the hands 4, 5 can be read;
at least a first and a second bezel 9, 10 coupled movable in rotation to the containing member 6 to rotate substantially around the dial 2 and provided with respective indicative scales 11 for reading at least an additional time datum in conjunction with the hands 4, 5.

Preferably, the term “additional time datum” means a time, such as related to another time zone, the elapsed time as of a given instant, and/or the like.

Conveniently, the bezels 9, 10 have different diameters, so that they are arranged concentric to each other, preferably inside each other, to substantially define an inner bezel and an outer bezel.

According to the invention, the bezels 9, 10 are mounted on the containing member 6 to substantially surround the dial 2.

In other words, the dial 2 is centered within the inner bezel.

Advantageously, the bezels 9, 10 rotate around a central axis A, preferably arranged in the center of the dial 2, so as to adjust the angular position of the bezels themselves and their respective indicative scales 11.

Specifically, the watch 1 comprises at least one rotational assembly 25a, 25b, 25c, arranged between one of the bezels 9, 10 and one of either the containing member 6 or the other of the bezels 9, 10.

In addition, the rotational assembly 25a, 25b, 25c is provided with at least one rotating body 12 which is in contact with at least one of the bezels 9, 10 due to the rotation of at least one of the same, thus promoting the rotation thereof and reducing the friction thereof with the other of the bezels 9, 10 and/or the containing member 6.

According to a possible, but not exclusive, embodiment of the watch 1, the rotating body 12 is a sphere.

Specifically, the rotating body 12 rotates in contact with at least one of the bezels 9, 10 and in contact with the other of the bezels 9, 10 and/or the containing member 6.

Specifically, the rotating body 12 rotates around at least one axis of rotation B on which it is centered due to the rotation of at least one of the bezels 9, 10.

Appropriately, the axis of rotation B is spaced away and preferably parallel to the central axis A.

Conveniently, it cannot be ruled out that the rotating body 12 may perform a motion of revolution around the central axis A and a motion of rotation on itself around the axis of rotation B due to the rotation of at least one of the bezels 9, 10.

Advantageously, the rotating body 12 is positioned in contact, preferably direct contact, between one of the bezels 9, 10 and at least one of the containing member 6 and the other of the bezels 9, 10.

Specifically, the rotating body 12 is mounted movable in rotation on one of the first bezel 9, the second bezel 10 or the containing member 6.

Therefore, the rotating body 12 rotates around its own axis of rotation B and simultaneously rotates around the central axis A as a result of the rotation of one of the bezels 9, 10 on which it is mounted.

Advantageously, the rotational assembly 25a, 25b, 25c comprises a plurality of rotating bodies 12 distributed in a radial pattern, centered around an axis of reference C.

Preferably, the rotating bodies 12 are spaced apart from each other and distributed in a radial pattern, centered around the axis of reference C.

In this way, the rotating bodies 12 substantially create a bearing mechanism.

Advantageously, the axis of reference C coincides with the central axis A.

Advantageously, the rotational assembly 25a, 25b, 25c comprises:
a plurality of hollow bodies 13, mounted or made, on at least one of either the first bezel 9, the second bezel 10 or the containing member 6, each of the hollow bodies 13 housing at least one of the rotating bodies 12 arranged, in use, projecting outside the same hollow body; and/or
at least one guiding profile 14 extending circularly around the dial 2 and made on another of either the first bezel 9, the second bezel 10 or the containing member 6, substantially opposite the plurality of rotating bodies 12, which rotate resting on the guiding profile 14.

In particular, the hollow bodies 13 are arranged facing the guiding profile 14.

In more detail, the hollow bodies 13 are distributed in a radial pattern, centered around the axis of reference C.

Preferably, the hollow bodies 13 are spaced apart from each other.

Advantageously, the guiding profile 14 defines at least one groove and/or a relief within which and/or on which the rotating body 12 rotates.

Conveniently, the rotating body 12 projects laterally from the hollow body 13 positioned between one of the bezels 9, 10 and at least one of either the containing member 6 or the other of the bezels 9, 10.

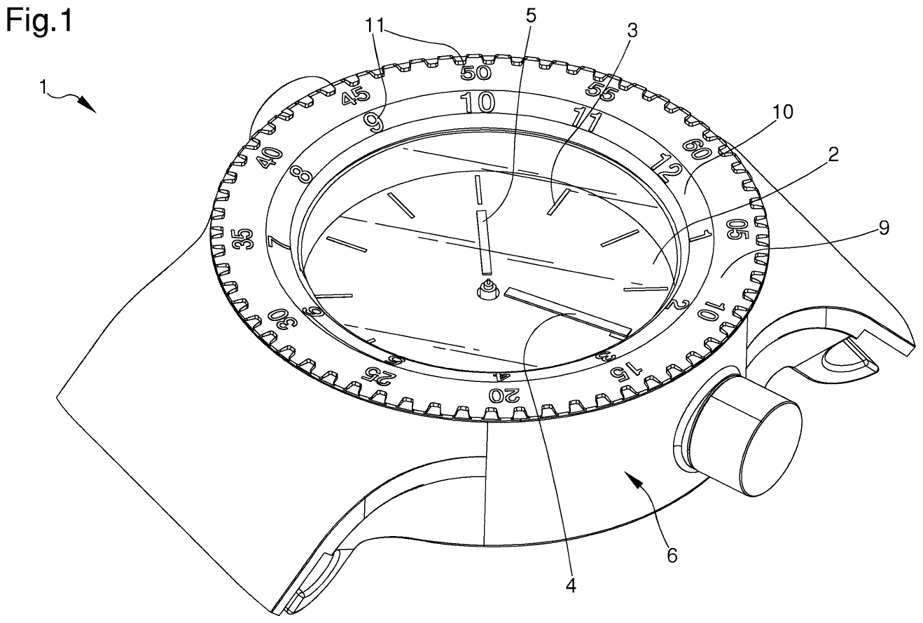

The term “lateral” employed with reference to one or more elements of the watch 1 is intended to indicate the arrangement of those elements in a configuration of normal use of the watch 1, such as that shown in FIG. 1, wherein the watch 1 rests on a plane with the dial 2 facing upwards.

In particular, the guiding profile 14 extends laterally to receive the rotating body 12.

For example, the guiding profile 14 defines a sliding track on which the rotating body runs in rotation.

In more detail, in the configuration of standard use of the watch 1, the guiding profile 14 is arranged below the rotating body 12, e.g., to prevent it from falling. Conveniently, the watch 1 comprises a plurality of rotational assemblies 25a, 25b, 25c.

In addition:
at least one of the rotational assemblies 25a is arranged between one of the bezels 9, 10 and one of either the containing member 6 or the other of the bezels 9, 10; and/or
at least another of the rotational assemblies 25b is arranged between the other of the bezels 9, 10 and the containing member 6; and/or
at least a further rotational assembly 25c is arranged between the bezels 9, 10.

Advantageously, according to the invention, the watch 1 comprises both the rotational assembly 25a and the other rotational assembly 25b as well as the further rotational assembly 25c. Further embodiments of the watch 1, wherein it comprises any combination of the rotational assemblies 25a, 25b, 25c cannot however be ruled out.

Preferably, the further rotational assembly 25c is directly positioned between the bezels 9, 10.

Conveniently, the containing member 6 defines at least one groove 20 within which at least one of the bezels 9, 10 is accommodated.

In more detail, with reference to the configuration of standard use of the watch 1, the groove 20 extends along a substantially vertical direction of extension.

In addition, in the same configuration, the groove 20 is open at the top and the insertion of at least one of the bezels 9, 10 within the groove 20 occurs along the direction of extension, from the top to the bottom.

Specifically, both bezels 9, 10 are inserted inside the groove 20 closing it at the top.

Advantageously, the containing member 6 comprises an outer side bank 15 and an inner side bank 16, which are substantially concentric and opposite each other, defining the groove 20.

Appropriately, the outer side bank 15 substantially faces the outer bezel and the inner side bank 16 substantially faces the inner bezel.

Specifically, according to a possible, but not exclusive embodiment of the watch 1, at least one rotational assembly 25a is located between the outer side bank 15 and the outer bezel, the other rotational assembly 25b is located between the inner bezel and the inner side bank 16 and the further rotational assembly 25c is located between the outer bezel and the inner bezel.

Conveniently, the watch 1 comprises at least one blocking assembly 30, located between one of the bezels 9, 10 and at least one of the containing member 6 and the other of the bezels 9, 10 and provided with at least one blocking element 21, mounted on one of the first bezel 9, the second bezel 10 or the containing member 6 and movable between at least one forward position, wherein it is exposed projecting outside the same between the first bezel 9, the second bezel 10 and the containing member 6, and at least one rearward position, wherein it is inserted further inside the same between the first bezel 9, the second bezel 10 and the containing member 6 with respect to the forward position.

Specifically, in use, the blocking element 21 is arranged laterally, located between one of the bezels 9, 10 and at least one of the containing member 6 and the other of the bezels 9, 10.

In more detail, in the forward position, in use, the blocking element 21, mounted on one of the containing member 6, the first bezel 9 and the second bezel 10, abuts against another of the containing member 6, the first bezel 9 and the second bezel 10.

Preferably, the blocking element 21 comprises a projecting portion 26, e.g. having a substantially spherical or hemispherical conformation, adapted to abut against such another of the containing member 6, the first bezel 9 and the second bezel 10.

In this way, the blocking element 21 secures at least one of the bezels 9, 10 to the containing member 6.

Conveniently, the blocking assembly 30 comprises at least one elastically deformable body 19 operating on the blocking element 21 to enable the movement thereof between the forward position and the rearward position.

Specifically, the elastically deformable element 19 is at least partly loaded in the rearward position, tending to move the rotating body 12 to the forward position, and is at least partly unloaded in the forward position, tending to keep the rotating body 12 in the same position.

Appropriately, the blocking element 21 is movable between the forward position and the rearward position due to the insertion of at least one of the bezels 9, 10 within the groove 20.

In other words, in this way, the rotating body 12 creates a latch mechanism of coupling at least one of the bezels 9, 10 to the containing member 6 and/or to the other of the bezels 9, 10.

In fact, during the insertion of one of the bezels 9, 10 within the groove 20, the rotating body 12 abuts against at least one of the first bezel 9, the second bezel 10 and the containing member 6 and is thus moved from the forward position to the rearward position.

In the rearward position, the rotating body 12 presses on one of the first bezel 9, the second bezel 10 and the containing member 6 by fastening at least one of the bezels 9, 10 within the groove 20.

Advantageously, the blocking assembly 30 comprises at least one housing body 27, mounted or made on one of the first bezel 9, the second bezel 10 and the containing member 6, and adapted to accommodate the blocking element 21.

In more detail, the blocking element 21 is movable within the housing body 27 between the forward position and the rearward position.

Conveniently, the housing body 27 defines an access gap 18 through which the blocking element 21 faces the outside of the same housing body 27.

In addition, the housing body 27 defines an abutment section 17, preferably defining the access gap 18, and adapted to prevent the rotating body 12 from being completely removed from the same housing body.

Advantageously, the blocking element 21 comprises a stopping section 28, which is associated with the projecting portion 26 and is adapted to abut against the abutment section 17 to prevent the blocking element 21 from being completely removed from the housing body 27.

In this way, the projecting portion 26 partly faces through the access gap 18, outside the housing body 27, while always remaining at least partly constrained within the same.

Preferably, the housing body 27 is coupled to at least one of the first bezel 9, the second bezel 10 and the containing member 6 in a removable manner.

Further embodiments of the watch 1 cannot however be ruled out wherein the housing body 27 can be made directly on one of the first bezel 9, the second bezel 10 or the containing member 6.

Conveniently, the elastically deformable element 19 is inserted within the housing body 27.

Appropriately, the blocking assembly 30 comprises a plurality of blocking elements 21 which are distributed in a radial pattern and centered around the axis of reference C.

Preferably, the blocking elements 21 are spaced apart from each other.

In addition, the blocking assembly 30 comprises a housing body 27 for each blocking element 21.

Again, the blocking assembly 30 comprises one elastically deformable element 19 for each blocking element 21.

Advantageously, the blocking assembly 30 comprises at least one seat 29 which develops circularly around the dial 2 and is made on one of the containing member 6, the first bezel 9 and the second bezel 10 substantially opposite the blocking element 21, which, in use, is inserted within the seat 29 in the forward position.

Specifically, the seat 29 extends substantially transversely, preferably orthogonally, with respect to the direction of extension of the groove 20.

In more detail, the seat 29 extends laterally to receive the blocking element 21.

For example, the seat 29 defines a sliding channel within which the blocking element 21 is housed, in use.

Specifically, in use, in the forward position, the blocking element 21 is free to rotate within the seat 29, along the extension of the same, so as to allow the rotation of the bezels 9, 10.

At the same time, in this configuration, the blocking element 21 prevents at least one of the bezels 9, 10 from being removed from the groove 20.

In fact, during the insertion of one of the bezels 9, 10 within the groove 20, the blocking element remains in the rearward position until it reaches the seat 29.

Specifically, at the seat 29, the blocking element 21 is free to be moved to the forward position to be accommodated within the same seat.

In this way, the seat 29 holds the blocking element 21 inside it and prevents the bezels 9, 10 from being removed outside the groove 20.

Advantageously, the watch 1 comprises coupling means 22a, 23a, 22b, 23b of the bezels 9, 10.

Specifically, the coupling means 22a, 23a, 22b, 23b are operable due to the rotation of at least one of the bezels 9, 10 to move the same between:
at least a first adjustment configuration, wherein the first bezel 9 is rotated in a first direction of rotation D and the coupling means 22a, 23a, 22b, 23b couple the second bezel 10 locked together in rotation to the first bezel 9;
at least a second adjustment configuration, wherein the first bezel 9 is rotated in a second direction of rotation E, opposite the first direction of rotation D and the coupling means 22a, 23a, 22b, 23b uncouple the second bezel 10 from the first bezel 9, allowing the latter to rotate freely in the second direction of rotation E.

In other words, in the first adjustment configuration, the first bezel 9 drags the second bezel 10 in rotation in the first direction of rotation D.

In this way, the angular position of the second bezel 10 is adjusted due to the rotation of the first bezel 9 in the first direction of rotation D.

In the second configuration, however, the second bezel 10 is free from the first bezel 9, the angular position of which is therefore adjusted in the second direction of rotation E.

Preferably, the first direction of rotation D is clockwise and the second direction of rotation E is counterclockwise or vice versa.

Advantageously, in the second adjustment configuration, the coupling means 22a, 23a, 22b, 23b couple the second bezel 10 to the containing member 6, thus preventing the second bezel 10 from rotating in the second direction of rotation E.

This expedient allows the position of the second bezel 10 to be secured during the rotation of the first bezel 9 in the second direction of rotation E.

In addition, in the first working configuration, the coupling means 22a, 23a, 22b, 23b uncouple the second bezel 10 from the containing member 6, allowing the free rotation of the second bezel 10 in the first direction of rotation D.

This expedient allows the angular position of the second bezel 10 to be adjusted due to the rotation of the first bezel 9 in the first direction of rotation D.

Specifically, the coupling means 22a, 23a, 22b, 23b comprise:
at least one coupling assembly 22a, 23a, arranged between the bezels 9, 10 and adapted to couple and uncouple the bezels 9, 10 in the first and in the second adjustment configurations, respectively; and/or
at least another coupling assembly 22b, 23b, arranged between the containing member 6 and the second bezel 10 and adapted to couple and uncouple the second bezel 10 to the containing member 6 in the second and in the first adjustment configurations, respectively.

Preferably, the coupling means 22a, 23a, 22b, 23b comprise both the coupling assembly 22a, 23a and the other coupling assembly 22b, 23b.

Specifically, the coupling assembly 22a, 23a comprises:
at least one notched profile 22a, associated with one of the bezels 9, 10 and extending circularly around the dial 2;
at least one abutment element 23a, associated with the other of the bezels 9, 10 and abutting on the notched profile 22a to make a ratchet mechanism adapted to couple and uncouple the bezels 9, 10 in the first and in the second adjustment configurations, respectively.

Advantageously, the other coupling assembly 22b, 23b comprises:
at least another notched profile 22b, associated with one of the containing member 6 and the second bezel 10 and running circularly around the dial 2;
at least another abutment element 23b, associated with the other of the containing member 6 and the second bezel 10 and abutting against the other notched profile 22b to make another ratchet mechanism adapted to couple and uncouple the second bezel 10 to the containing member 6 in the second and in the first adjustment configurations, respectively.

Preferably, the term “ratchet mechanism” is intended to indicate that the notched profile 22a/the other notched profile 22b allows the abutment element 23a/the other abutment element 23b to slide in rotation stopping on the same profile only in one direction of sliding.

In the opposite direction, on the other hand, the rotational sliding of the abutment element 23a/of the other abutment element 23b on the notched profile 22a/on the other notched profile 22b is blocked by the same profile.

Preferably, the notched profile 22a/the other notched profile 22b comprises a plurality of teeth, e.g. having sawtooth conformation or the like, distributed in a circular pattern.

Usefully, the abutment element 23a and/or the other abutment element 23b is made of elastically deformable material so as to allow the teeth of the notched profile 22a/the other notched profile 22b to be overridden.

In particular, the abutment element 23a and/or the other abutment element 23b slide smoothly along the inclined side of the teeth, easily overriding them.

On the contrary, the abutment element 23a and/or the other abutment element 23b abuts against the side of the teeth opposite the inclined side, by interlocking therein.

According to the invention, the teeth of notched profile 22a are oriented in the same way as the teeth of the other notched profile 22b.

Conveniently, the watch 1 comprises manual movement means 24, 25 of the first bezel 9 in the first and in the second directions of rotation E.

Preferably, the movement means 24, 25 comprise a crown 24 and a motion transmission assembly 25, located between the crown 24 and at least one of the bezels 9, 10.

In this way, the motion transmission assembly 25 transmits the rotary motion given to the crown 24 to at least one of the bezels 9, 10.

Usefully, the motion transmission assembly 25 comprises a pair of sprockets, meshing with each other, wherein a first sprocket is associated with the crown 24 and the other sprocket is associated with one of the bezels 9, 10.

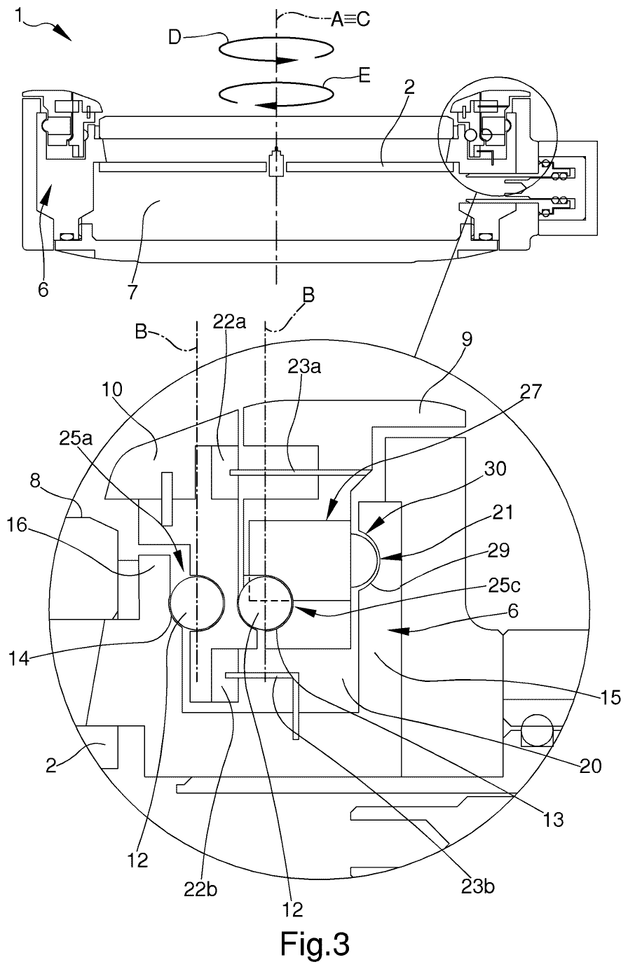

According to the possible, but not exclusive, embodiment of the watch 1 shown in FIG. 3, the first bezel 9 is the outer bezel and the second bezel 10 is the inner bezel.

In addition, the notched profile 22a is associated with the second bezel 10 and the abutment element 23a is associated with the first bezel 9.

Specifically, in this embodiment the first direction of rotation D is counterclockwise.

Therefore, in the first configuration of adjustment, the abutment element 23a pushes the notched profile 22a into rotation in the first direction of rotation D.

In the second configuration of adjustment, the abutment element 23a is free to slide on the notched profile 22a.

Referring to FIG. 3, the other notched profile 22b is associated with the second bezel 10, and the other abutment element 23b is associated with the containing member 6.

Therefore, in the first configuration of adjustment, the other abutment element 23b slides on the other notched profile 22b.

In the second configuration of adjustment, the other abutment element 23b blocks the sliding of the other notched profile 22b.

Conveniently, the rotational assembly 25a is positioned between the outer bezel and the containing member 6, and the further rotational assembly 25c is positioned between the bezels 9, 10. However, in this embodiment, the watch 1 is without the other rotational assembly 25b.

According to this embodiment, the blocking assembly 30 is positioned between the first bezel 9 and the containing member 6.

In this embodiment, the watch 1 is without the movement means 24, 25 and the first bezel 9 is rotated manually to adjust its angular position and the angular position of the second bezel 10.

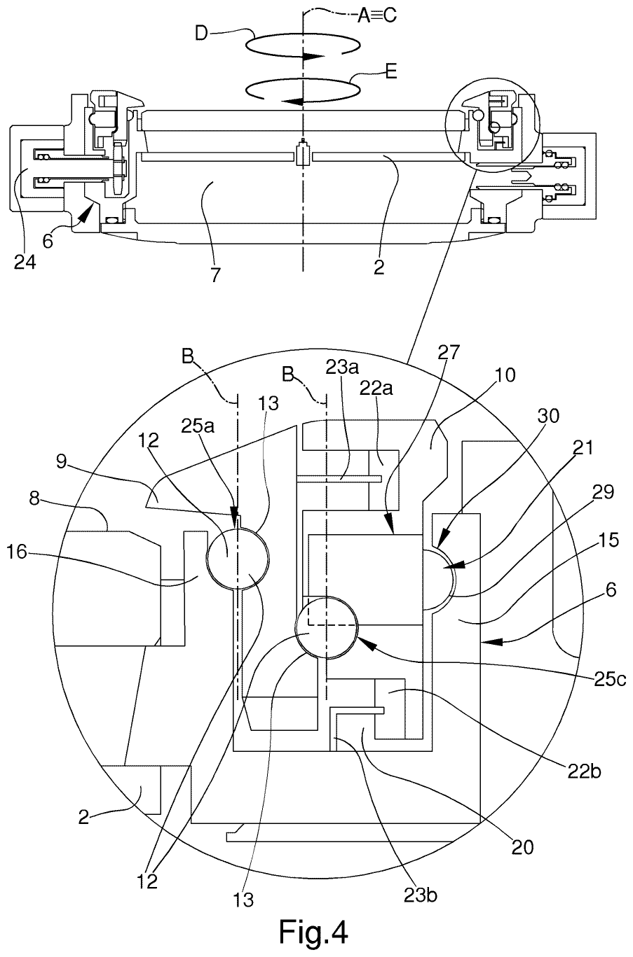

FIG. 4 shows another possible, but not exclusive, embodiment of the watch 1 that differs from the previous one in that the first bezel 9 is the inner bezel and the second bezel 10 is the outer bezel.

Moreover, this embodiment differs from the previous one because it comprises the movement means 24, 25.

Specifically, the movement means 24, 25 operate on the inner bezel to adjust the angular position of the latter and that of the outer bezel.

In more detail, the motion transmission assembly 25 is positioned between the crown 24 and the inner bezel.

It has in practice been ascertained that the described invention achieves the intended objects.

Particularly noteworthy is the fact that the rotating body allows the watch bezels to be turned smoothly, quickly and particularly easily.

In addition, the rotating body allows for a simple and functional inner structure of the watch which simplifies the execution of the assembly/disassembly operations of the bezels.

1. A wristwatch comprising:
at least one dial provided with a reference scale;
at least one hand mechanism provided with at least one minute hand and at least one hour hand for reading a time on said reference scale;
at least one containing member defining at least one housing of said at least one hand mechanism and of said at least one dial and defining at least one upper opening through which said at least one dial and said hands of said at least one hand mechanism can be read;
at least a first and a second bezel coupled movable in rotation to said containing member to rotate substantially around said at least one dial and provided with respective indicative scales for reading an additional time datum in conjunction with said hands;
at least one rotational assembly, arranged between one of said at least a first and a second bezels and one of either said containing member or the other of said at least a first and a second bezels, said at least one rotational assembly being provided with at least one rotating body in contact with at least one of said bezels due to the rotation of at least one of the same, for promoting the rotation thereof and reducing the friction thereof with the other of said bezels and/or said containing member.

2. The wristwatch according to claim 1, wherein said rotating body is a sphere.

3. The wristwatch according to claim 1, wherein said rotational assembly comprises a plurality of said rotating bodies distributed in a radial pattern, centered around an axis of reference.

4. The wristwatch according to claim 1, wherein said rotational assembly comprises:
a plurality of hollow bodies, mounted or made, on at least one of either said first bezel, said second bezel or said containing member, each of said hollow bodies housing at least one of said rotating bodies arranged, in use, projecting outside the same hollow body; and/or
at least one guiding profile extending circularly around said dial and made on another of either said first bezel, said second bezel or said containing member, substantially opposite said plurality of rotating bodies, which rotate resting on said guiding profile.

5. The wristwatch according to claim 1, further comprising: a plurality of rotational assemblies (25a, 25b, 25c); and
at least one of said rotational assemblies is arranged between one of said bezels and one of either said containing member or the other of said bezels; and/or
at least another of said rotational assemblies is arranged between the other of said bezels and said containing member; and/or
at least a further of said rotational assemblies is arranged between said bezels.

6. The wristwatch according to claim 1, further comprising: coupling means of said bezels, said coupling means being operable due to the rotation of at least one of said bezels to move the same between:
at least a first adjustment configuration, wherein said first bezel is rotated in a first direction of rotation and said coupling means couple said second bezel locked together in rotation to said first bezel; and
at least a second adjustment configuration, wherein said first bezel is rotated in a second direction of rotation, opposite said first direction of rotation and said coupling means uncouple said second bezel from said first bezel, allowing the latter to rotate freely in said second direction of rotation.

7. The wristwatch according to claim 6, wherein:
in said second rotational configuration said coupling means couple said second bezel to said containing member, preventing said second bezel from rotating in said second direction of rotation; and
in said first working configuration said coupling means uncouple said second bezel from said containing member, allowing the free rotation of said second bezel in said first direction of rotation.

8. The wristwatch according to claim 7, wherein said coupling means comprise:
at least one coupling assembly, arranged between said bezels and adapted to couple and uncouple said bezels in said first and in said second adjustment configurations, respectively; and/or
at least another coupling assembly, arranged between said containing member and said second bezel and adapted to couple and uncouple said second bezel to said containing member in said second and in said first adjustment configurations, respectively.

9. The wristwatch according to claim 8, wherein:
said at least one coupling assembly comprises:
at least one notched profile, associated with one of said bezels and extending circularly around said dial;
at least one abutment element, associated with the other of said bezels and abutting on said notched profile to make a ratchet mechanism adapted to couple and uncouple said bezels in said first and in said second adjustment configurations, respectively; and/or
said at least another coupling assembly comprises:
at least another notched profile, associated with one of the containing member and the second bezel and running circularly around said dial;
at least another abutment element, associated with the other of said containing member and said second bezel and abutting against said another notched profile to make another ratchet mechanism adapted to couple and uncouple said second bezel to said containing member in said second and in said first adjustment configurations, respectively.

10. The wristwatch according to claim 1, further comprising: manual movement means of said first bezel in said first and said second direction of rotation.
